(19) United States
(12) Patent Application Publication
(10) Pub. No.: US 2024/0085946 A1
(43) Pub. Date: Mar. 14, 2024

(54) PACKAGING TRAY AND SCREEN PROTECTOR ALIGNMENT DEVICE

(71) Applicant: FELLOWES MOBILE LLC, Itasca, IL (US)

(72) Inventors: Jack Dufelmeier, Chicago, IL (US); Richard Kang, Palatine, IL (US)

(21) Appl. No.: 18/464,919

(22) Filed: Sep. 11, 2023

Related U.S. Application Data
(60) Provisional application No. 63/405,209, filed on Sep. 9, 2022.

(51) Int. Cl. G06F 1/16; B65D 1/36; B65D 43/02; B65D 81/36; H04B 1/3888

(52) U.S. Cl. CPC G06F 1/1603; B65D 1/36; B65D 43/0202; B65D 81/36; H04B 1/3888; B65D 2543/00194; B65D 2543/00342

(57) ABSTRACT

Disclosed herein is an improved packaging for a portable electronic device such as a smartphone. The packaging included features that allow the packaging to be used as an alignment or guide device to apply a screen protector to a screen of the portable electronic device.

### BACKGROUND OF THE INVENTION

### Field of the Invention

The invention relates to packaging for portable electronic device. The invention also relates to devices for aligning or applying screen protectors to displays of portable electronic devices.

### Background Art

Screen protectors for smartphones and other devices with display screens have become popular for providing added protection to the expensive devices. The screen protectors are generally thin sheets of material such as polymer films and adhered to the screen with adhesives. Installation of such screen protectors requires precise alignment of the screen protector to the display so as to avoid misalignment as the adhesives used do not readily allow for removal and realignment. Even if a protector allows for realignment, best results and optical clarity occur when the screen protector is positioned correctly in the first instance of application.

### SUMMARY OF THE INVENTION

The invention disclosed herein is packaging tray that also functions as an alignment device for the screen protector. In other embodiments, the device may act as a packaging tray for the smartphone and screen protector as well as an alignment device. With such a combination of functions, a manufacturer may reduce the amount of packaging material needed and provide the consumer with a device for installation of the screen protector.

In one form, the invention is directed to a tray for packaging a screen protector and aligning the screen protector with a portable electronic device. The tray includes an outer perimeter wall and an inner perimeter wall connected to each other by a connecting wall, a lid including a lid perimeter wall, and a cover wall spanning between portions of the lid perimeter wall. The inner perimeter wall defines a well for receiving the portable electronic device for installation of the screen protector. The lid perimeter wall is outside of the tray perimeter wall when the lid is placed on the tray to form a package. The tray outer perimeter wall includes at least one retention structure registered with at least one complementary retention structure on the lid perimeter wall.

In one form, the at least one complementary retention structure on the lid perimeter wall is a protrusion on the inside of a corner or the lid perimeter wall. The at least one complementary retention structure on the tray is a depression.

In one form, the lid cover wall includes a depression. The depression is capable of receiving a camera bump of a back of a portable electronic device.

In one form, the tray inner perimeter wall includes a guide edge defining in part an aperture. The aperture is slightly larger than the screen protector.

In one form, the tray further includes a guide tab along a guide edge. The guide tab registers with a notch in the screen protector when the tray is used as a guide to align the screen protector with a screen of the portable electronic device.

In one form, the portable electronic device is within the well. The screen protector is positioned between the back of the portable electronic device and the lid cover wall.

In one form, the lid cover wall is suspended above a surface and the lid perimeter wall is in contact with the surface, at least a portion of the portable electronic device is received within the well, the back of the portable electronic device is in contact with the lid cover wall, and the tray is positioned above the lid.

In one form, the lid includes protrusions on the cover wall. The protrusions on the cover wall extend away from the well of the cover wall.

In one form, the invention is directed to a tray for packaging a screen protector and aligning the screen protector with a portable electronic device. The tray includes an outer perimeter wall and an inner perimeter wall connected to each other by a connecting wall, a lid including a lid perimeter wall, a cover wall spanning between portions of the lid perimeter wall, retention means on the lid for securing the lid onto the tray to package the portable electronic device, and guide means for guiding the screen protector onto the portable electronic device. The inner perimeter wall defines a well for receiving the portable electronic device for installation of the screen protector. The lid perimeter wall is outside of the tray perimeter wall when the lid is placed on the tray to form a package.

In one form, the tray further includes means for accommodating a camera bump of the portable electronic device.

In one form, the tray further includes means for elevating the portable electronic device above a surface when a portion of the portable electronic device is in the well of the tray.

In one form, the tray perimeter wall has a height that is less than the thickness of the portable electronic device.

In one form, the tray further includes means for securing the lid to the tray when the lid is placed on the tray to form a package.

In one form, at least a portion of the tray inner perimeter wall conforms to a portion of the front surface of the portable electronic device.

In one form, the invention is directed to an assembly for packaging a portable electronic device and guiding a screen protector onto a display of the portable electronic device. The tray includes an outer perimeter wall and an inner perimeter wall joined by a connecting wall. The inner perimeter wall conforms with at least a portion of the portable electronic device. At least a portion of the inner perimeter wall extends to a guide edge. The guide edge forms at least a portion of an aperture for receiving a screen protector.

In one form, the assembly includes a lid. The lid has a lid perimeter wall and a cover wall spanning the lid perimeter wall. The lid perimeter wall receives the tray outer perimeter wall to form a package with the portable electronic device therebetween.

In one form, the well depth is less than the thickness of the portable electronic device.

In one form, the guide edge is less than 0.1 mm from an edge of the screen protector when the screen protector is guided onto the portable electronic device.

In one form, the lid includes accommodation means to accommodate the camera bump of the portable electronic device so that the portable electronic device may lie flat upon the lid cover wall.

### BRIEF DESCRIPTION OF THE DRAWINGS

FIG. 1 is an exploded top perspective view of the tray, screen protector, smartphone, and lid of the present invention.

FIG. 2 is an exploded left side elevational view of the tray, screen protector, smartphone, and lid of the present invention.

FIG. 3 is an exploded left side elevational view of the tray, screen protector, smartphone, and lid of the present invention.

FIG. 4 is an exploded top perspective view of the tray, screen protector, smartphone, and lid of the present invention.

FIG. 5 is a perspective cross sectional view of the packaged smartphone within the assembled tray and lid, including the installed screen protector.

FIG. 6 a elevational cross sectional view of the packaged smartphone within the assembled tray and lid, including the installed screen protector.

FIG. 7 is a perspective diagonal cross sectional view of the packaged smartphone within the assembled tray and lid, including the installed screen protector.

FIG. 8 is a perspective view of a smartphone placed in the well of the tray, the tray acting as an application guide for a screen protector being tipped onto the screen of the smartphone.

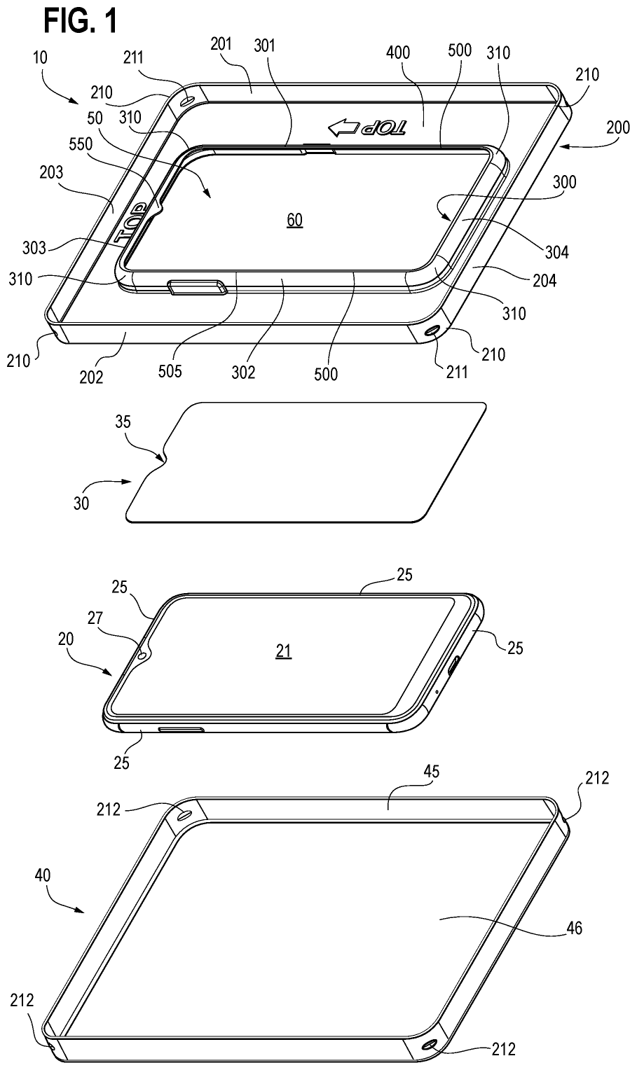

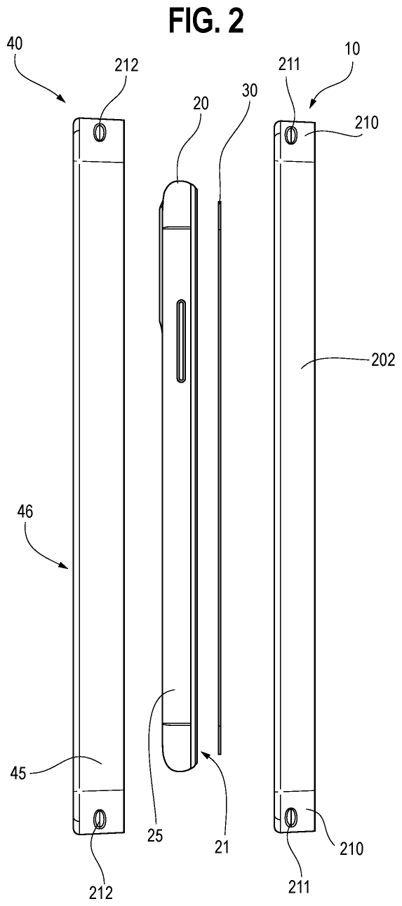

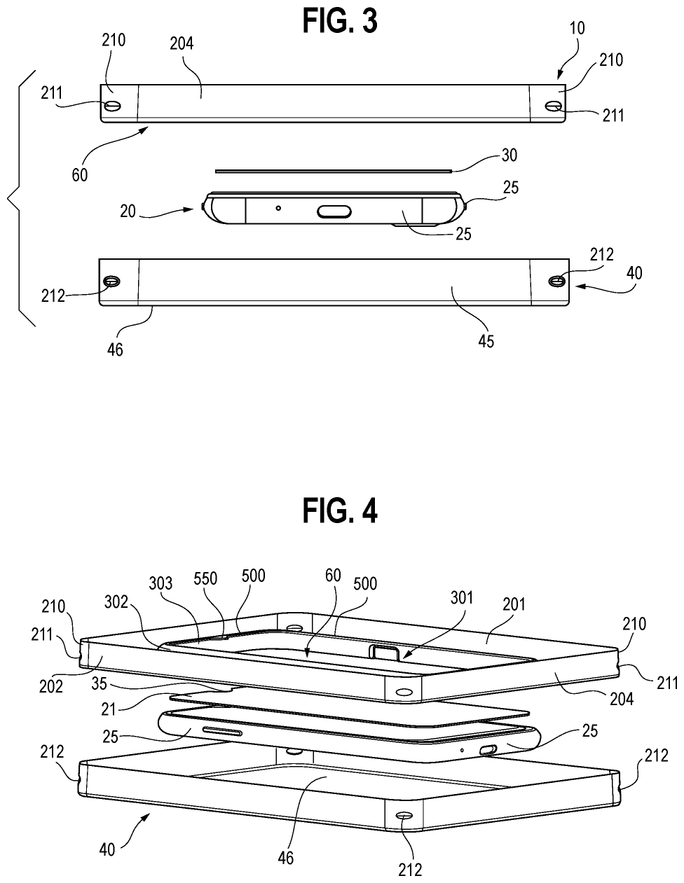

### DETAILED DESCRIPTION OF THE PREFERRED EMBODIMENT

With reference to the Figures, in some embodiments the device or tray 10 includes an outer perimeter wall 200, an inner perimeter wall 300, and a connecting wall 400 extending between the inner perimeter wall 300 and the outer perimeter wall 200. The walls may be formed of any material. In the most preferred embodiment, the walls are made of a thermoplastic that is blow molded or vacuum molded into a thin web or film. A suitable nonexclusive list of materials includes polyurethane, PVC, polyacrylate, The walls are generally of the same thickness, but may be of different thicknesses. In the most preferred embodiment, the walls are between 0.3 and 0.5 mm thick. In other embodiments, the walls may be of any convenient thickness used in the packaging industry.

In some embodiments the outer perimeter wall 200 may include a number of sections such as a top outer perimeter wall 203, a bottom outer perimeter wall 204, a first side outer perimeter wall 201, and a second side outer perimeter wall 202. The outer perimeter wall 200 may include curved corner sections 210 at each corner of the perimeter wall 200. In other embodiments, the perimeter wall 200 sections may meet at angles.

In some embodiments, the outer perimeter wall corner sections 210 include depressions 211. The depressions 211 are shaped to receive protrusions 212 on the lid 40. One skilled in the art will recognize that the depressions and protrusions may be switched. In other embodiments, other complementary structures may be used to secure the lid 40 to the tray 10. One skilled in the art will also recognize that a depression on one side of a thin web or film or sheet of material may form a protrusion on the other side of the web, sheet, or film.

In some embodiments the lid 40 includes a lid perimeter wall 45, and a cover wall 46 extending between or over the lid perimeter wall 45 to form a lid with a well. In some embodiments, the cover wall 46 may extend beyond the bounds of the lid perimeter wall 45. The lid 40 is sized to fit over the tray 10 and engage with the tray 10 via the depressions 210 and protrusions 212 to form a package for smart phone 20 or screen protector 30, or other device or contents. The tray 10 may be viewed as nesting within the lid 40 in some embodiments.

In some embodiments the lid perimeter wall 45 is not continuous and may be intermittent. In some embodiments, a side of the perimeter wall may be eliminated, allowing the tray 10 to slide out a side of the lid 40 rather than being placed or nested from above or below.

The inner perimeter wall 300 includes a top inner perimeter wall 303, a bottom inner perimeter wall 304, a first side inner perimeter wall 301, and a second side inner perimeter wall 302. The inner perimeter wall 300 may include curved corners 310 to join the inner perimeter wall sections described above. The inner perimeter wall 300 may extend from the connecting wall 400 in the same direction as the outer perimeter wall 200.

In some embodiments, the inner perimeter wall 300 and the outer perimeter wall 200 include surfaces that oppose each other in a spaced apart relation. In some embodiments, the outer perimeter wall is in a perpendicular relationship to the connecting wall 400.

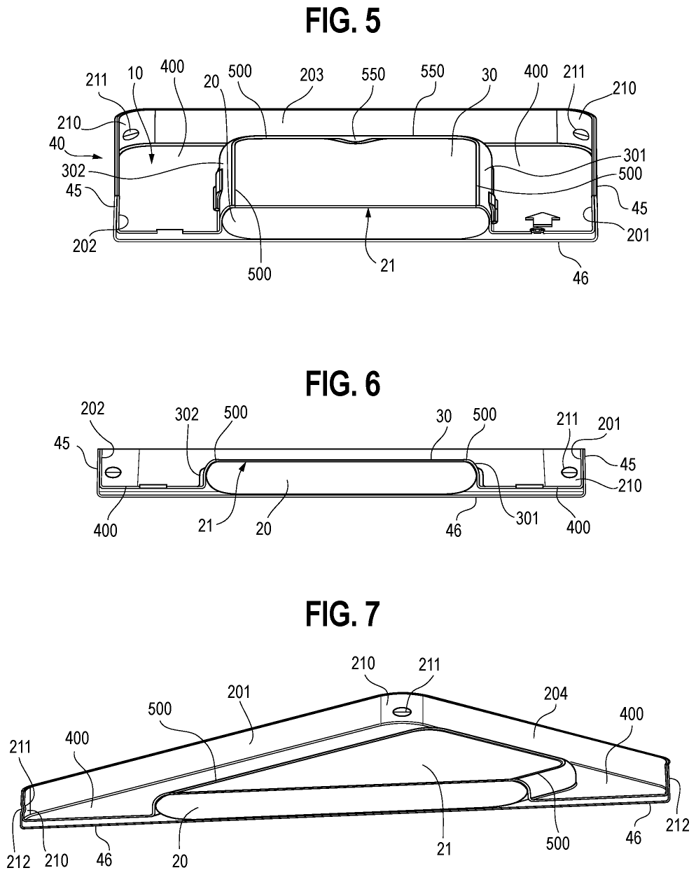

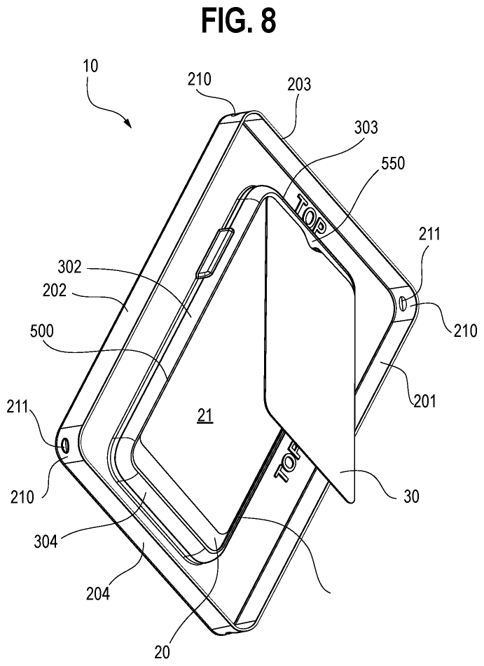

In some embodiments, the inner perimeter wall 300 is shaped to conform at least a portion of the shape of a smartphone 20. The inner perimeter wall 300 preferably conforms to at least a portion of the side perimeter 25 of the smartphone 20. When considered from the direction of the connecting wall 400 to the extending guide edge 500 of the inner perimeter wall 300, the inner perimeter wall 300 forms a well 60 or receiving area for receiving the smartphone 20. As shown in FIGS. 5,6, and 7, the well 60 is occupied by at least a portion of the phone 20. One skilled in the art will recognize from those figures that the well is oriented upside down. That is the phone 20 is placed into the well 60 from the bottom. One may also view the arrangement as the tray 10 being placed over or onto the phone 20. One skilled in the art will also recognize that the well 60 has an aperture 50.

The inner perimeter wall 300 preferably wraps or extends around the to at least a portion of a front surface of the smartphone 20 when the smartphone 20 is placed in the tray 10. With such wrapping or extension of the inner perimeter wall 300, the smartphone 20 is positioned in the well 60 of the tray 10 and secured from lateral movement. The smartphone 20 is also secured from passing through the opening or aperture 50 in the well 60 when the smartphone side perimeter 25 is in contact with the inner perimeter wall 300 in a conforming relationship. The aperture 50 is sized to accept the screen protector 30 within the bounds of the edge guides 500.

When the lid 40 is placed over the tray 10 in an engaging relationship to form a package, the smartphone 20 may be contained or packaged therebetween and restrained from movement out of the package by the lid 40 in one direction, and by the extension of the inner perimeter wall 200 in the opposite direction. In the package, the lid 40 contains the smartphone 20 in the well 60 of the tray 10. The screen protector 30 may also be placed in and contained in the package. While the screen protector 30 may reside anywhere in the package, it is preferable to locate the screen protector 20 between the back of the smartphone 20 and the lid 40. When forming a package, the lid 40 is placed over the tray 10 so that the outer perimeter wall 200 of the tray 10 are to the inside of the lid perimeter wall 45. One skilled in the art will recognize that while the drawings and description reference the lid 40 being placed over the tray 10, the invention may also be considered in the inverted position, with the tray 10 being nested into the lid 40, with the lid 40 being on the bottom of the tray 10. In some embodiments, the lid perimeter wall and the outer perimeter wall are coextensive in height when forming a package.

In some embodiments, the lid perimeter wall and the outer perimeter wall are not coextensive.

In some embodiments the inner perimeter wall 300 extends from the connecting wall 400 and terminates at a guide edge 500. The purpose of the guide edge 500 is to guide or limit the movement of the screen protector 30 as it is placed or lowered onto the display or screen of the smartphone 20 or other device with a display. The guide edge 500 may extend to the perimeter of the display 21 of the smartphone 20.

In some embodiments, the guide edge 500 may include a top inner perimeter wall guide edge, a bottom inner perimeter wall guide edge, a first inner perimeter wall guide edge, and a second inner perimeter wall guide edge. The recited inner perimeter guide edges may be joined to one another or they may be unjoined. In some embodiments the guide edge 500 may be straight. In other embodiments, the guide edge may include ridges, disjoined sections, or any profile desired so long as the guided edge 500 can guide or limit movement of the screen protector 30 as it is placed on the display 21 of a smartphone 20 or other device.

In some embodiments, the guide edge includes a guide tab 550. The guide tab 550 extends from the guide edge 500 so as to provide registration between the tray 10 and screen protector 30 when installing the screen protector 30 on the smartphone display 21. In some embodiments, the guide tab 550 is placed over the front facing camera lens 27 of the smartphone 20 when the smartphone is placed in the tray 10.

The guide edge 500 generally forms an aperture 50. The aperture 50 is sized to receive a screen protector 30. The dimensions of the aperture 50 should be slightly larger than the width and length of the screen protector 30 so as to guide or restrict the movement or misalignment of the screen protector 20 as it is lowered or tipped onto the screen 21 of a portable electronic device such as a smartphone 20.

When installing the screen protector 20 onto the screen 21 of the smartphone when the smartphone is in the tray 10, or the tray 10 is on top of the smartphone 20 with the smartphone 20 in the well, the guide tab 550 is engaged with the guide notch 35 and the screen protector 20 is tipped or lowered onto the display 21 of the smartphone 20. In some embodiments, the guide edge 500 should be approximately 0.1 mm or less away from the side edges of the screen protector 30 to provide guidance and allow the screen protector to be placed onto the screen without catching the guide edge 500 between the screen protector 30 and the screen 21.

In some embodiments the perimeter wall 200 is generally rectangular. In other embodiments, the perimeter wall 200 may take any shape that is convenient for packaging.

In some embodiments the perimeter wall 200 is has a height that is slightly higher than the thickness smart phone it is used with. With such a height, when the smartphone 20 is positioned in the well 50 formed by the inner perimeter walls 300, neither the display nor the back surface of the smartphone 20 extends beyond the planes formed by the edges of the outer perimeter wall 200. In other words, the height of the perimeter wall is greater than the thickness of the smartphone 20. The height of the inner perimeter wall 300 is less than the height of the outer perimeter wall 200. The height of the walls is considered the dimension in the direction normal to the connecting wall 400 shown in the Figures.

In some embodiments, the lid 40 may include a depression or accommodation in the cover wall 46. In use for the application of the screen protector, the lid 10 may be used as an elevated base. In such an arrangement or use, the lid 40 may be placed on a surface such as a table top so that the lid perimeter wall 45 is in contact with the surface and the lid cover wall 46 is suspended above the surface. The smartphone 20 may be placed on the cover wall 46 so that any bulge of the smartphone 20, such as the back facing main camera or cameras, may be placed into the depression, opening, or other accommodation to allow the smartphone 20 to otherwise lay flat on the lid 40. The tray 10 may then be placed over the smartphone 20. Similarly, in some embodiments, the lid cover wall 46 may include projections that extend outwardly or away from the well of the lid 40 and surface on which the lid 40 is positioned upon. These projections in some embodiments may be placed to support or suspend a smartphone 20 above the cover wall 46. This support allows the smartphone, particularly a thin smartphone, to be more fully positioned into the tray 10 during application of the screen protector.

The foregoing disclosure of specific embodiments is intended to be illustrative of the broad concepts comprehended by the invention and not limitations.

1. A tray for packaging a screen protector and aligning the screen protector with a portable electronic device the tray including an outer perimeter wall and an inner perimeter wall connected to each other by a connecting wall, the inner perimeter wall defining a well for receiving the portable electronic device for installation of the screen protector, a lid including a lid perimeter wall, and a cover wall spanning between portions of the lid perimeter wall, the lid perimeter wall being outside of the tray perimeter wall when the lid is placed on the tray to form a package, the tray outer perimeter wall including at least one retention structure registered with at least one complementary retention structure on the lid perimeter wall.

2. The tray of claim 1, wherein the at least one complementary retention structure on the lid perimeter wall is a protrusion on the inside of a corner or the lid perimeter wall and the at least one complementary retention structure on the tray is a depression.

3. The tray of claim 1, the lid cover wall including a depression, the depression capable of receiving a camera bump of a back of a portable electronic device.

4. The tray of claim 1, wherein the tray inner perimeter wall includes a guide edge defining in part an aperture, the aperture slightly larger than the screen protector.

5. The tray of claim 4, further including a guide tab along a guide edge, the guide tab registering with a notch in the screen protector when the tray is used as a guide to align the screen protector with a screen of the portable electronic device.

6. The tray of claim 5, wherein the portable electronic device is within the well and the screen protector is positioned between the back of the portable electronic device and the lid cover wall.

7. The tray of claim 3, the lid cover wall being suspended above a surface and the lid perimeter wall being in contact with the surface, at least a portion of the portable electronic device received within the well, the back of the portable electronic device in contact with the lid cover wall, the tray being positioned above the lid.

8. The tray of claim 1, the lid including protrusions on the cover wall, the protrusions on the cover wall extending away from the well of the cover wall.

9. A tray for packaging a screen protector and aligning the screen protector with a portable electronic device the tray including an outer perimeter wall and an inner perimeter wall connected to each other by a connecting wall, the inner perimeter wall defining a well for receiving the portable electronic device for installation of the screen protector, a lid including a lid perimeter wall, and a cover wall spanning between portions of the lid perimeter wall, the lid perimeter wall being outside of the tray perimeter wall when the lid is placed on the tray to form a package, retention means on the lid for securing the lid onto the tray to package the portable electronic device, guide means for guiding the screen protector onto the portable electronic device.

10. The tray of claim 9, further including means for accommodating a camera bump of the portable electronic device.

11. The tray of claim 10, further including means for elevating the portable electronic device above a surface when a portion of the portable electronic device is in the well of the tray.

12. The tray of claim 11, wherein the tray perimeter wall has a height that is less than the thickness of the portable electronic device.

13. The tray of claim 9 further including means for securing the lid to the tray when the lid is placed on the tray to form a package.

14. The tray of claim 9, wherein at least a portion of the tray inner perimeter wall conforms to a portion of the front surface of the portable electronic device.

15. An assembly for packaging a portable electronic device and guiding a screen protector onto a display of the portable electronic device, the tray including an outer perimeter wall and an inner perimeter wall joined by a connecting wall, the inner perimeter wall conforming with at least a portion of the portable electronic device, at least a portion of the inner perimeter wall extending to a guide edge, the guide edge forming at least a portion of an aperture for receiving a screen protector.

16. The assembly of claim 15, the assembly including a lid, the lid including a lid perimeter wall and a cover wall spanning the lid perimeter wall, the lid perimeter wall receiving the tray outer perimeter wall to form a package with the portable electronic device therebetween.

17. The assembly of claim 15, wherein the well depth is less than the thickness of the portable electronic device.

18. The assembly of claim 15, wherein the guide edge is less than 0.1 mm from an edge of the screen protector when the screen protector is guided onto the portable electronic device.

19. The assembly of claim 16, the lid including accommodation means to accommodate the camera bump of the portable electronic device so that the portable electronic device may lie flat upon the lid cover wall.
